(19) United States
(12) Patent Application Publication
(10) Pub. No.: US 2003/0096166 A1
(43) Pub. Date: May 22, 2003

(54) Nickel-hydrogen storage battery

(76) Inventors: Teruhiko Imoto, Itano-gun (JP); Masaru Kihara, Takasaki-shi (JP); Tatsuya Aizawa, Itano-gun (JP); Motoo Tadokoro, Itano-gun (JP); Yoshitaka Baba, Takasaki-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/278,993

(22) Filed: Oct. 24, 2002

(30) Foreign Application Priority Data
Oct. 25, 2001 (JP) P. 2001-327285

(51) Int. Cl. H01M 4/58; H01M 4/52; H01M 4/32; H01M 4/62; H01M 4/38

(52) U.S. Cl. 429/218.2; 429/223; 429/232

(57) ABSTRACT

The invention provides a nickel-hydrogen storage battery which shows no deterioration of high rate discharge performance even after prolonged storage. The nickel-hydrogen storage battery of the invention comprises a positive electrode containing a positive active material mainly composed of nickel hydroxide, a negative electrode containing a negative active material mainly composed of a hydrogen-absorbing alloy and an alkaline electrolytic solution, wherein the positive electrode comprises a positive active material mainly composed of nickel hydroxide coated with a cobalt compound having at least one compound selected from the group consisting of niobium compound, titanium compound, magnesium compound and tungsten compound incorporated therein and the negative electrode comprises a CaCu₅ type hydrogen-absorbing alloy represented by the chemical formula MmNiₐCo_{b}Mn_{c}M_{d} (in which M represents at least one element selected from the group consisting of Ca, Mg and Al), with the proviso that the ratio (c/(c+d)) of the composition (c+d) of Mn and M to the composition (c) of Mn has the following relationship:

0.58≦c/(c+d)≦0.67

In this arrangement, a nickel-hydrogen storage battery can be obtained which shows no deterioration of high rate discharge performance even after prolonged storage.

### FIELD OF THE INVENTION

The present invention relates to a nickel-hydrogen storage battery comprising a positive electrode containing a positive active material mainly composed of nickel hydroxide, a negative electrode containing a negative active material mainly composed of a hydrogen-absorbing alloy and an alkaline electrolytic solution.

### BACKGROUND OF THE INVENTION

In recent years, with the spread of small portable appliances, there has been a growing demand for rechargeable secondary batteries (storage batteries). In particular, with the recent demand for reduction of size and thickness of appliances and efficient use of space in appliances, there has been a rapidly growing demand for nickel-hydrogen storage battery allowing a large capacity. This kind of a nickel-hydrogen storage battery is produced by spirally winding a positive electrode comprising nickel hydroxide as a positive active material and a negative electrode comprising a hydrogen-absorbing alloy as a negative active material with a separator interposed therebetween to form a spiral electrode block, receiving the spiral electrode block in a metallic outer case (battery case) with an alkaline electrolytic solution, and then sealing the metallic outer case.

In these days, the demand for this kind of a nickel-hydrogen storage battery has been further increased. This kind of a nickel-hydrogen storage battery has found wide application not only in small appliances but also in large current appliances such as electric tool. With this trend, improvements have been made in both positive electrode and negative electrode in an attempt to provide a larger current. For example, improvements in positive electrode have been normally carried out by incorporating a small amount of a cobalt compound as an electrically-conducting agent in an active material mainly composed of nickel hydroxide.

However, the mere incorporation of a cobalt compound as an electrically-conducting agent is not sufficient to obtain a high capacity and high performance nickel-hydrogen storage battery. Therefore, an alkaline heat treatment process which comprises coating the surface of nickel hydroxide with a cobalt compound, and then heating the nickel hydroxide in the presence of an alkali and oxygen has been proposed in Japanese Patent Publication H01-200555. In accordance with the alkaline heat treatment process proposed in the above mentioned Japanese Patent Publication H10-200555, a cobalt compound is heated in the presence of an alkali and oxygen to produce a high order cobalt compound having a high conductivity, making it possible to enhance the percent utilization of active material and hence attain a higher capacity.

However, when a high order cobalt compound having a high conductivity is produced on the surface of an active material (nickel hydroxide) as proposed in the above cited Japanese Patent Publication H01-200555, cobalt compounds taking no part in reaction are uniformly present on the surface of nickel hydroxide. Accordingly, nickel hydroxide and the electrolytic solution cannot come in contact with each other, deteriorating the high rate discharge performance of the battery to disadvantage. In order to solve this problem, an approach has been proposed which comprises coating part of the surface of nickel hydroxide with a high order cobalt compound containing alkaline cations. In accordance with this approach, a good conduction network can be formed. At the same time, the electrolytic solution can come in direct contact with nickel hydroxide. Accordingly, both the percent utilization of active material and the high rate discharge performance can be enhanced.

On the other hand, for the negative electrode part, an approach has been proposed in Japanese Patent Publication H05-225975 which comprises removing a surface oxide film that lowers the electrical conductivity between hydrogen-absorbing alloy particles. The approach proposed in the above mentioned Japanese Patent Publication H05-225975 is effective to remove rare earth oxides constituting the surface oxide film by dipping the hydrogen-absorbing alloy in hydrochloric acid but is disadvantageous in that it is not too effective to remove nickel hydroxides and oxides and causes further production of nickel hydroxides. As an approach for further enhancing the conductivity of the hydrogen-absorbing alloy particles there has been proposed a method involving the reduction of nickel oxides or hydroxides to metallic nickel, i.e., reduction of the surface of the alloy in a hydrogen atmosphere having a temperature and pressure that doesn't allow the alloy to absorb hydrogen, in Japanese Patent Publication H09-237628.

However, even the aforementioned improvements in positive electrode and negative electrode are disadvantageous in that the nickel-hydrogen storage battery thus activated shows a deteriorated high rate discharge performance when discharged with a large current after prolonged storage. The reason why such a nickel-hydrogen storage battery shows a deteriorated high rate discharge performance when discharged with a large current is presumably as follows. In other words, even when the hydrogen-absorbing alloy to be used as a negative electrode is freed of surface oxide by the method disclosed in the above cited Japanese Patent Publication H05-225975 or Japanese Patent Publication H09-237628, it is again subjected to surface oxidation by the electrolytic solution after prolonged storage and hence deterioration of the surface activity thereof. Accordingly, the discharge performance of the negative electrode is deteriorated, resulting in the deterioration of high rate discharge performance of the battery.

For the positive electrode part, metal ions such as manganese (Mn) and aluminum (Al) ions constituting the hydrogen-absorbing alloy dissolved in the electrolytic solution penetrate into the positive electrode through the segregated area of the cobalt compound formed on the surface of nickel hydroxide to destroy the good conduction network. Thus, the discharge performance of the positive electrode is deteriorated, resulting in the deterioration of high rate discharge performance of the battery.

### SUMMARY OF THE INVENTION

Under these circumstances, the invention has been worked out to solve the aforementioned problem that a nickel-hydrogen storage battery shows deteriorated high rate discharge performance after prolonged storage. It is therefore an aim of the invention to provide a nickel-hydrogen storage battery which shows no deterioration of high rate discharge performance even after prolonged storage.

The foregoing aim of the invention will become apparent from the following detailed description and examples.

In order to solve the aforementioned problems, the nickel-hydrogen storage battery according to the invention is characterized in that the positive electrode comprises a positive active material mainly composed of nickel hydroxide coated with a cobalt compound having at least one compound selected from the group consisting of niobium compound, titanium compound, magnesium compound and tungsten compound incorporated therein and the negative electrode contains a CaCu₅ type hydrogen-absorbing alloy represented by the chemical formula MmNiₐCo_{b}Mn_{c}M_{d} (in which M represents at least one element selected from the group consisting of Ca, Mg and Al), with the proviso that the ratio (c/(c+d)) of the composition (c+d) of Mn and M to the composition (c) of Mn has the following relationship:

0.58≦c/(c+d)≦0.67

The incorporation of at least one compound selected from the group consisting of niobium compound, titanium compound, magnesium compound and tungsten compound in the positive electrode makes it possible to lower the rate at which the cobalt compound covering the surface of nickel hydroxide which is an active material is dissolved and precipitated in the electrolytic solution. As a result, the structure of the cobalt compound layer can be rendered denser. Further, the denser structure of the cobalt compound layer can prevent metals such as Mn, Al, Ca and Mg constituting the hydrogen-absorbing alloy which have been eluted with the electrolytic solution after prolonged storage from penetrating into the cobalt coat layer, making it possible to maintain a good conduction network.

When the ratio (c/(c+d)) of the composition (c+d) of Mn and M to the composition (c) of Mn of the hydrogen-absorbing alloy represented by the chemical formula MmNiₐCo_{b}Mn_{c}M_{d} (in which M represents at least one element selected from the group consisting of Ca, Mg and Al) satisfies the following relationship: 0.58≦c/(c+d)≦0.67, the effect exerted by the incorporation of the niobium compound, titanium compound, magnesium compound and tungsten compound in the positive electrode can be maximized.

When the cobalt compound contains alkaline cations, the electrical conductivity of the cobalt compound layer can be enhanced. Further, the effect exerted by the incorporation of the niobium compound, titanium compound, magnesium compound and tungsten compound can be further enhanced.

In this case, when the amount of the niobium compound, titanium compound, magnesium compound and tungsten compound to be incorporated in the positive electrode is too small, the effect of lowering the effect at which the covering cobalt compound is dissolved and precipitated in the electrolytic solution and the effect of preventing segregation on the surface of nickel hydroxide cannot be exerted sufficiently. On the contrary, when the amount of the niobium compound, titanium compound, magnesium compound and tungsten compound to be incorporated in the positive electrode is too great, the amount of nickel hydroxide which acts as an active material in the nickel positive electrode is too great, the resulting discharge capacity is decreased. Therefore, the amount of the niobium compound, titanium compound, magnesium compound and tungsten compound to be incorporated in the positive electrode is preferably from not smaller than 0.2% by mass to not greater than 1.0% by mass based on the total mass of active materials in the nickel positive electrode.

As the niobium compound there is preferably used one selected from the group consisting of Nb₂O₅, Nb₂O₃, NbO, NbO₂, NaNbO₃, LiNbO₃, KNbO₃ and Nb₂O₅.xH₂O. As the titanium compound there is preferably used one selected from the group consisting of TiO₂, Ti₂O₃ and TiO. As the magnesium compound there is preferably used one selected from the group consisting of MgO and Mg(OH)₂. As the tungsten compound there is preferably used one selected from the group consisting of WO₂, WO₃ and Na₂WO₄.

### DETAILED DESCRIPTION OF THE INVENTION

Embodiments of implementation of the invention will be further described hereinafter, but the invention should not be construed as being limited thereto. Proper changes may be made on these embodiments without departing from the scope of the invention.

1. Nickel Electrode

(1) Preparation of Positive Active Material

To an aqueous solution of a mixture of nickel sulfate, zinc sulfate and cobalt sulfate having zinc and cobalt contents of 3% and 1% by mass based on 100% by mass of metallic nickel, respectively, was added gradually an aqueous solution of sodium hydroxide with stirring. The pH value of the reaction solution was then kept to a range of from 13 to 14 to cause particulate nickel hydroxide to be precipitated. To the solution having particulate nickel hydroxide precipitated therein was then added an aqueous solution of cobalt sulfate. The pH value of the reaction solution was then kept to a range of from 9 to 10 to cause cobalt hydroxide to be precipitated around a spherically particulate hydroxide mainly composed of nickel hydroxide as a crystal nucleus.

As a result, a particulate nickel hydroxide having a cobalt hydroxide coat layer provided on the surface there of (particulate positive active material) was obtained. Thereafter, the particulate positive active material was subjected to alkaline heat treatment involving spray with an alkaline solution in a heat air flow. During this alkaline heat treatment, the particulate positive active material was sprayed with an alkaline solution (aqueous solution of sodium hydroxide) in an amount of 35% by mass, which is 5 times the amount of cobalt, while the temperature of the particulate positive material was being adjusted to 60° C. Thereafter, the reaction mixture was heated to a temperature of 90° C. until the temperature of the particulate positive material reached 90° C. Subsequently, the particulate positive material was washed with water, and then dried at a temperature of 60° C. to obtain a positive active material. In this manner, a nickel hydroxide powder having a highly conductive film of sodium-containing cobalt compound formed on the surface of a particulate nickel hydroxide was obtained.

(2) Preparation of Active Material Slurry

Subsequently, the positive active material thus prepared was mixed with a niobium compound (e.g., Nb₂O₅) to obtain a mixture. 500 g of the mixture was then mixed with 200g of a 0.25 mass-% HPC (hydroxylpropyl cellulose) dispersion to prepare an active material slurry. The active material slurry prepared by adding the niobium compound (Nb₂O₅) in an amount of 0.1% by mass based on the mass of the positive active material was referred to as “a1”. Similarly, the active material slurry prepared by adding the niobium compound (Nb₂O₅) in an amount of 0.3% by mass based on the mass of the positive active material was referred to as “b1”. The active material slurry prepared by adding the niobium compound (Nb₂O₅) in an amount of 0.5% by mass based on the mass of the positive active material was referred to as “c1”.

Similarly, the active material slurry prepared by adding the niobium compound (Nb₂O₅) in an amount of 0.7% by mass based on the mass of the positive active material was referred to as “d1”. The active material slurry prepared by adding the niobium compound (Nb₂O₅) in an amount of 1.0% by mass based on the mass of the positive active material was referred to as “e1”. The active material slurry prepared by adding the niobium compound (Nb₂O₅) in an amount of 1.5% by mass based on the mass of the positive active material was referred to as “f1”. The active material slurry prepared free of niobium compound (Nb₂O₅) was referred to as “g1”. As the niobium compound to be incorporated in the positive active material there may be used Nb₂O₃, NbO, NbO₂, NaNbO₃, LiNbO₃, KNbO₃, Nb₂O₅.xH₂O or the like besides Nb₂O₅.

(3) Preparation of Nickel Positive Electrode

An electrode substrate made of foamed nickel having a thickness of 1.7 mm was filled with the active material slurries a1, b1, c1, d1, e1, f1 and g1, respectively, in such an amount that a predetermined packing density was reached. Thereafter, the electrode substrates were each dried, rolled to a thickness of 0.75 mm, and then cut into a predetermined size to prepare non-sintered nickel positive electrodes a, b, c, d, e, f and g, respectively.

The non-sintered nickel positive electrode prepared from the active material slurry a1 was referred to as “positive electrode a”. Similarly, the non-sintered nickel positive electrode prepared from the active material slurry b1 was referred to as “positive electrode b”. The non-sintered nickel positive electrode prepared from the active material slurry c1 was referred to as “positive electrode c”. The non-sintered nickel positive electrode prepared from the active material slurry d1 was referred to as “positive electrode d”. The non-sintered nickel positive electrode prepared from the active material slurry e1 was referred to as “positive electrode e”. The non-sintered nickel positive electrode prepared from the active material slurry f1 was referred to as “positive electrode f”. The non-sintered nickel positive electrode prepared from the active material slurry g1 was referred to as “positive electrode g”.

2. Hydrogen-Absorbing Alloy Negative Electrode

(1) Preparation of Hydrogen-Absorbing Alloy

A Mischmetal (Mm), nickel (Ni: purity of 99.9%), cobalt (Co), aluminum (Al) and manganese (Mn) were mixed in a predetermined molar ratio. The mixture thus obtained was then induction-heated in a high frequency induction furnace having an argon gas atmosphere to prepare a molten alloy. The molten alloy thus obtained was injected into a casting mold by a known method, and then cooled to prepare an ingot of a hydrogen-absorbing alloy represented by the chemical formula: MmNiₐCo_{b}Mn_{c}Al_{d}. The hydrogen-absorbing alloy ingot thus prepared was then mechanically ground to an average particle diameter of about 60 μm.

MmNi_{3.48}Co_{0.80}Mn_{0.42}Al_{0.30} (c/c+d=0.58) having Nm:Ni:Co:Mn:Al molar ratio of 1.0:3.48:0.80:0.42:0.30 was referred to as “hydrogen-absorbing alloy h1”. MmNi_{3.50}Co_{0.80}Mn_{0.42}Al_{0.28} (c/c+d=0.60) having Nm:Ni:Co:Mn:Al molar ratio of 1.0:3.50:0.80:0.42:0.28 was referred to as “hydrogen-absorbing alloy i1”. MmNi_{3.60}Co_{0.80}Mn_{0.40}Al_{0.20} (c/c+d=0.67) having Nm:Ni:Co:Mn:Al molar ratio of 1.0:3.60:0.80:0.40:0.20 was referred to as “hydrogen-absorbing alloy j1”.

Further, MmNi_{3.61}Co_{0.80}Mn_{0.32}Al_{0.27} (c/c+d=0.54) having Nm:Ni:Co:Mn:Al molar ratio of 1.0:3.61:0.80:0.32:0.27 was referred to as “hydrogen-absorbing alloy k1”. MmNi_{3.40}Co_{0.80}Mn_{0.60}Al_{0.20} (c/c+d=0.75) having Nm:Ni:Co:Mn:Al molar ratio of 1.0:3.40:0.80:0.60:0.20 was referred to as “hydrogen-absorbing alloy l1”.

(2) Preparation of Hydrogen-Absorbing Alloy Negative Electrode

Subsequently, 100 parts by mass of each of these hydrogen-absorbing alloy powders were mixed with 20 parts by mass of a 5 mass-% aqueous solution of a polyethylene oxide (PEO) as a binder to prepare a hydrogen-absorbing alloy paste. The hydrogen-absorbing alloy thus prepared was applied to both the surfaces of a core material made of a punching metal, dried at room temperature, rolled to a predetermined thickness, and then cut into a predetermined size to prepare hydrogen-absorbing alloy negative electrodes h, i, j, k and l, respectively.

The hydrogen-absorbing alloy negative electrode comprising the hydrogen-absorbing alloy h1 was referred to as “negative electrode h”. The hydrogen-absorbing alloy negative electrode comprising the hydrogen-absorbing alloy i1 was referred to as “negative electrode i”. The hydrogen-absorbing alloy negative electrode comprising the hydrogen-absorbing alloy j1 was referred to as “negative electrode j”. The hydrogen-absorbing alloy negative electrode comprising the hydrogen-absorbing alloy k1 was referred to as “negative electrode k”. The hydrogen-absorbing alloy negative electrode comprising the hydrogen-absorbing alloy l1 was referred to as “negative electrode l”.

3. Nickel-Hydrogen Storage Battery

(1) Preparation of Nickel-Hydrogen Storage Battery

The non-sintered nickel positive electrodes a, b, c, d, e, f and g and hydrogen-absorbing alloy negative electrodes h, i, j, k and l thus prepared were each spirally wound with a separator made of a nonwoven polypropylene fabric provided interposed therebetween to prepare electrode blocks. These electrode blocks were each inserted in an outer case. A negative electrode lead extending from the negative electrode in the electrode block was connected to the outer case while a positive electrode lead extending from the positive electrode was connected to a positive electrode cover provided in a sealing material. Thereafter, an electrolytic solution (e.g., 30 mass-% aqueous solution of potassium hydroxide) was injected in the outer case. The opening of the outer case was then sealed with the sealing material to prepare AA size nickel-hydrogen storage batteries having a nominal capacity of 1,250 mAh.

The nickel-hydrogen storage battery comprising the positive electrode a and the negative electrode h was referred to as “battery A”. The nickel-hydrogen storage battery comprising the positive electrode b and the negative electrode h was referred to as “battery B”. The nickel-hydrogen storage battery comprising the positive electrode c and the negative electrode h was referred to as “battery C”. The nickel-hydrogen storage battery comprising the positive electrode d and the negative electrode h was referred to as “battery D”. The nickel-hydrogen storage battery comprising the positive electrode e and the negative electrode h was referred to as “battery E”. The nickel-hydrogen storage battery comprising the positive electrode f and the negative electrode h was referred to as “battery F”. The nickel-hydrogen storage battery comprising the positive electrode a and the negative electrode i was referred to as “battery G”. The nickel-hydrogen storage battery comprising the positive electrode b and the negative electrode i was referred to as “battery H”. The nickel-hydrogen storage battery comprising the positive electrode c and the negative electrode i was referred to as “battery I”. The nickel-hydrogen storage battery comprising the positive electrode d and the negative electrode i was referred to as “battery J”. The nickel-hydrogen storage battery comprising the positive electrode e and the negative electrode i was referred to as “battery K”. The nickel-hydrogen storage battery comprising the positive electrode f and the negative electrode i was referred to as “battery L”.

The nickel-hvdrogen storage battery comprising the positive electrode a and the negative electrode j was referred to as “battery M”. The nickel-hydrogen storage battery comprising the positive electrode b and the negative electrode j was referred to as “battery N”. The nickel-hydrogen storage battery comprising the positive electrode c and the negative electrode j was referred to as “battery O”. The nickel-hydrogen storage battery comprising the positive electrode d and the negative electrode j was referred to as “battery P”. The nickel-hydrogen storage battery comprising the positive electrode e and the negative electrode j was referred to as “battery Q”. The nickel-hydrogen storage battery comprising the positive electrode f and the negative electrode j was referred to as “battery R”. The nickel-hydrogen storage battery comprising the positive electrode g and the negative electrode h was referred to as “battery S”. The nickel-hydrogen storage battery comprising the positive electrode c and the negative electrode k was referred to as “battery T”. The nickel-hydrogen storage battery comprising the positive electrode g and the negative electrode k was referred to as “battery U”. The nickel-hydrogen storage battery comprising the positive electrode c and the negative electrode l was referred to as “battery V”. The nickel-hydrogen storage battery comprising the positive electrode g and the negative electrode l was referred to as “battery W”. The nickel-hydrogen storage battery comprising the positive electrode g and the negative electrode j was referred to as “battery X”.

(2) Measurement of Discharge Capacity

Subsequently, the batteries A to X thus prepared were each charged with a charge current of 100 mA at a temperature of 25° C. for 16 hours, and then discharged with a discharge current of 1,000 mA to a battery voltage of 1.0 V. Thereafter, these batteries were each charged with a charge current of 100 mA for 16 hours, and then discharged with a discharge current of 4,000 mA to 0.5 V. From the discharge time was then determined the initial high rate discharge capacity (mAh) of the batteries A to X.

Subsequently, the batteries A to X were each allowed to stand at a temperature of 25° C. for 30 days, charged with a charge current of 100 mA for 16 hours, and then discharged with a discharge current of 4,000 mA to a battery voltage of 0.5 V. From the discharge time was then determined the aged high rate discharge capacity (mAh) of the batteries A to X. The ratio (%) of the aged high rate discharge capacity (mAh) to the initial high rate discharge capacity (mAh) was then calculated as percent retention of high rate discharge capacity after aging. The results are set forth in Table 1.

TABLE 1

| | Nickel positive | | | | | Initial | | Percent |
|---|---|---|---|---|---|---|---|---|
| Kind of | electrode | | Hydrogen-absorbing alloy negative electrode | | | discharge | Aged | retention of |
| battery | Kind | Nb₂O₅ | Kind | Chemical formula | c/(c + d) | capacity | capacity | capacity |
| A | a | 0.1 | h | MₘNi_{3.48}Co_{0.80}Mn_{0.42}Al_{0.30} | 0.58 | 841 | 774 | 92.0 |
| B | b | 0.2 | h | MₘNi_{3.50}Co_{0.80}Mn_{0.42}Al_{0.28} | 0.58 | 839 | 825 | 98.3 |
| C | c | 0.5 | h | MₘNi_{3.50}Co_{0.80}Mn_{0.42}Al_{0.28} | 0.58 | 840 | 829 | 98.7 |
| D | d | 0.7 | h | MₘNi_{3.50}Co_{0.80}Mn_{0.42}Al_{0.28} | 0.58 | 838 | 829 | 98.9 |
| E | e | 1.0 | h | MₘNi_{3.50}Co_{0.80}Mn_{0.42}Al_{0.28} | 0.58 | 832 | 817 | 98.2 |
| F | f | 1.5 | h | MₘNi_{3.50}Co_{0.80}Mn_{0.42}Al_{0.28} | 0.58 | 824 | 752 | 91.3 |
| G | a | 0.1 | l | MₘNi_{3.60}Co_{0.80}Mn_{0.42}Al_{0.28} | 0.60 | 840 | 795 | 94.6 |
| H | b | 0.2 | l | MₘNi_{3.60}Co_{0.80}Mn_{0.42}Al_{0.28} | 0.60 | 839 | 830 | 98.9 |
| I | c | 0.5 | i | MₘNi_{3.60}Co_{0.80}Mn_{0.42}Al_{0.28} | 0.60 | 841 | 834 | 99.2 |
| J | d | 0.7 | l | MₘNi_{3.60}Co_{0.80}Mn_{0.42}Al_{0.28} | 0.60 | 837 | 830 | 99.2 |
| K | e | 1.0 | l | MₘNi_{3.60}Co_{0.80}Mn_{0.42}Al_{0.28} | 0.60 | 830 | 821 | 98.9 |
| L | f | 1.5 | l | MₘNi_{3.60}Co_{0.80}Mn_{0.42}Al_{0.28} | 0.67 | 815 | 795 | 97.5 |
| M | a | 0.1 | j | MₘNi_{3.60}Co_{0.80}Mn_{0.40}Al_{0.28} | 0.67 | 845 | 792 | 93.7 |
| N | b | 0.2 | j | MₘNi_{3.60}Co_{0.80}Mn_{0.40}Al_{0.20} | 0.67 | 837 | 830 | 99.2 |
| O | c | 0.5 | j | MₘNi_{3.60}Co_{0.80}Mn_{0.40}Al_{0.20} | 0.67 | 836 | 829 | 99.2 |
| P | d | 0.7 | j | MₘNi_{3.60}Co_{0.80}Mn_{0.40}Al_{0.20} | 0.67 | 834 | 827 | 99.2 |
| Q | e | 1.0 | j | MₘNi_{3.60}Co_{0.80}Mn_{0.40}Al_{0.20} | 0.67 | 829 | 820 | 98.9 |
| R | f | 1.5 | j | MₘNi_{3.60}Co_{0.80}Mn_{0.40}Al_{0.20} | 0.67 | 816 | 794 | 97.3 |
| S | g | 0 | h | MₘNi_{3.48}Co_{0.80}Mn_{0.42}Al_{0.30} | 0.58 | 840 | 594 | 70.7 |
| T | c | 0.5 | k | MₘNi_{3.61}Co_{0.80}Mn_{0.32}Al_{0.27} | 0.54 | 839 | 610 | 72.7 |
| U | g | 0 | k | MₘNi_{3.61}Co_{0.80}Mn_{0.32}Al_{0.27} | 0.54 | 841 | 599 | 71.2 |
| V | c | 0.5 | l | MₘNi_{3.40}Co_{0.80}Mn_{0.60}Al_{0.20} | 0.75 | 845 | 614 | 72.7 |
| W | g | 0 | l | MₘNi_{3.40}Co_{0.80}Mn_{0.60}Al_{0.20} | 0.75 | 843 | 596 | 70.7 |
| X | g | 0 | j | MₘNi_{3.60}Co_{0.80}Mn_{0.40}Al_{0.20} | 0.67 | 842 | 596 | 70.8 |

As can be seen in the results shown in Table 1 above, the batteries A to R comprising the nickel positive electrode having a niobium compound (Nb₂O₅) incorporated therein and the hydrogen-absorbing alloy negative electrode made of a hydrogen-absorbing alloy represented by the chemical formula MmNiₐCo_{b}Mn_{c}M_{d} satisfying the relationship 0.58≦c/(c+d)≦0.67 each showed a percent retention of high rate discharge capacity after 30 days of storage in discharged state as high as from 92.9% to 99.2%. In particular, the batteries B to E, H to K and N to Q comprising the nickel positive electrode having a niobium compound (Nb₂O₅) incorporated therein in an amount of from 0.2% to 1.0% by mass showed a percent retention of high rate discharge capacity as very high as from 98.2% to 99.2%. It can thus be said preferred that the amount of niobium compound (Nb₂O₅) to be incorporated in the nickel positive electrode be from 0.2% to 1.0% by mass based on the mass of the positive active material.

It can also be seen that the batteries T and V comprising the nickel positive electrode having a niobium compound (Nb₂O₅) incorporated therein in an amount of 0.5% by mass and the hydrogen-absorbing alloy negative electrode made of a hydrogen-absorbing alloy represented by the chemical formula MmNiₐCo_{b}Mn_{c}M_{d} in which c/(c+d) is 0.54 and 0.75, respectively, showed a percent retention of high rate discharge capacity after 30 days of storage in discharged state as low as from 72.7%. On the other hand, it can also be seen that the batteries U and W comprising the nickel positive electrode free of niobium compound (Nb₂O₅) and the hydrogen-absorbing alloy negative electrode made of a hydrogen-absorbing alloy represented by the chemical formula MmNiₐCo_{b}Mn_{c}M_{d} in which c/(c+d) is 0.54 and 0.75, respectively, showed a percent retention of high rate discharge capacity after 30 days of storage in discharged state as low as 7.2% and 70.7%, respectively. It can thus be said that when a hydrogen-absorbing alloy negative electrode made of a hydrogen-absorbing alloy represented by the chemical formula MmNiₐCo_{b}Mn_{c}M_{d} in which c/(c+d) is 0.54 or 0.75 is used, the desired effect of niobium compound (Nb₂O₅) cannot be exerted.

It can further be seen that the batteries S and X comprising the hydrogen-absorbing alloy negative electrode made of a hydrogen-absorbing alloy represented by the chemical formula MmNiₐCo_{b}Mn_{c}M_{d} in which c/(c+d) is 0.58 or 0.67 and the positive electrode free of niobium compound (Nb₂O₅) showed a percent retention of high rate discharge capacity as low as 70.7% or 70.8%, respectively.

Accordingly, the combined use of a hydrogen-absorbing alloy negative electrode made of a hydrogen-absorbing alloy represented by the chemical formula MmNiₐCo_{b}Mn_{c}M_{d} in which c/(c+d) is from 0.58 to 0.67 and a nickel positive electrode having a niobium compound (Nb₂O₅) incorporated therein in an amount of from 0.2% to 1.0% by mass makes it possible to exert a remarkable effect of enhancing the percent retention of high rate discharge capacity after storage in discharged state.

4. Study of Additive Compounds

While the aforementioned embodiment has been described with reference to the case where the positive active material has a niobium compound incorporated therein, the case where the positive active material has a titanium, magnesium or tungsten compound incorporated therein was studied as well.

(1) Titanium Compound

An active material slurry having a titanium compound (TiO₂) incorporated therein in an amount of 0.5% by mass was prepared. An electrode substrate made of foamed nickel was then filled with the active material slurry in the same manner as mentioned above. The electrode substrate was dried, rolled, and then cut into a predetermined size to prepare a non-sintered nickel positive electrode m in the same manner as mentioned above.

Subsequently, the non-sintered nickel positive electrode m and hydrogen-absorbing alloy negative electrodes h, i, j, k and l thus prepared were each spirally wound with a separator made of a nonwoven polypropylene fabric provided interposed therebetween to prepare electrode blocks. These electrode blocks were each inserted in an outer case. A negative electrode lead extending from the negative electrode in the electrode block was connected to the outer case while a positive electrode lead extending from the positive electrode was connected to a positive electrode cover provided in a sealing material. Thereafter, an electrolytic solution (e.g., 30 mass-% aqueous solution of potassium hydroxide) was injected in the outer case. The opening of the outer case was then sealed with the sealing material to prepare AA size nickel-hydrogen storage batteries having a nominal capacity of 1,250 mAh.

The nickel-hydrogen storage battery comprising the positive electrode m and the negative electrode k was referred to as “battery Z1”. The nickel-hydrogen storage battery comprising the positive electrode m and the negative electrode h was referred to as “battery Z2”. The nickel-hydrogen storage battery comprising the positive electrode m and the negative electrode l was referred to as “battery Z1”.

Subsequently, the batteries Z1 to Z4 thus prepared were each charged with a charge current of 100 mA at a temperature of 25° C. for 16 hours, and then discharged with a discharge current of 1,000 mA to a battery voltage of 1.0 V. Thereafter, these batteries were each charged with a charge current of 100 mA for 16 hours, and then discharged with a discharge current of 4,000 mA to 0.5 V. From the discharge time was then determined the initial high rate discharge capacity (mAh) of the batteries Z1 to Z4.

Subsequently, the batteries Z1 to Z4 which had been thus discharged were each allowed to stand at a temperature of 25° C. for 30 days, charged with a charge current of 100 mA for 16 hours, and then discharged with a discharge current of 4,000 mA to a battery voltage of 0.5 V. From the discharge time was then determined the aged high rate discharge capacity (mAh) of the batteries Z1 to Z4. The ratio (%) of the aged high rate discharge capacity (mAh) to the initial high rate discharge capacity (mAh) was then calculated as percent retention of high rate discharge capacity after aging. The results are set forth in Table 2 below. Table 2 also contains the results of the batteries U, S, W and X for comparison.

TABLE 2

| | Nickel | | | | | | | |
|---|---|---|---|---|---|---|---|---|
| | positive | | | | | Initial | | Percent |
| Kind of | electrode | | Hydrogen-absorbing alloy negative electrode | | | discharge | Aged | retention of |
| battery | Kind | TiO₂ | Kind | Chemical formula | c/(c + d) | capacity | capacity | capacity |
| Z1 | m | 0.5 | k | MₘNi_{3.61}Co_{0.80}Mn_{0.32}Al_{0.27} | 0.54 | 841 | 611 | 72.7 |
| Z2 | m | 0.5 | h | MₘNi_{3.48}Co_{0.80}Mn_{0.42}Al_{0.30} | 0.58 | 842 | 831 | 98.7 |
| Z3 | m | 0.5 | j | MₘNi_{3.60}Co_{0.80}Mn_{0.40}Al_{0.20} | 0.67 | 844 | 832 | 98.6 |
| Z4 | m | 0.5 | l | MₘNi_{3.40}Co_{0.80}Mn_{0.60}Al_{0.20} | 0.75 | 838 | 614 | 73.3 |
| U | g | 0 | k | MₘNi_{3.61}Co_{0.80}Mn_{0.32}Al | 0.54 | 841 | 599 | 71.2 |
| S | g | 0 | h | MₘNi_{3.48}Co_{0.80}Mn_{0.42}Al_{0.30} | 0.58 | 840 | 594 | 70.7 |
| W | g | 0 | l | MₘNi_{3.40}Co_{0.80}Mn_{0.60}Al_{0.20} | 0.75 | 843 | 596 | 70.7 |
| X | g | 0 | j | MₘNi_{3.60}Co_{0.80}Mn_{0.40}Al_{0.20} | 0.67 | 842 | 596 | 70.8 |

As can be seen in the results shown in Table 2 above, the batteries Z2 and Z3 comprising the nickel positive electrode having a titanium compound (TiO₂) incorporated therein in an amount of 0.5% by mass and the hydrogen-absorbing alloy negative electrode made of hydrogen-absorbing alloy represented by the chemical formula MmNiₐCo_{b}Mn_{c}M_{d} in which c/(c+d) is 0.58 or 0.67, respectively, showed a percent retention of high rate discharge capacity after 30 days of storage in discharged state as high as 98.6% and 98.7%, respectively. It can also be seen that the batteries Z1 and Z4 comprising the nickel positive electrode having a titanium compound (TiO₂) incorporated therein in an amount of 0.5% by mass and the hydrogen-absorbing alloy negative electrode made of hydrogen-absorbing alloy represented by the chemical formula MmNiₐCo_{b}Mn_{c}M_{d} in which c/(c+d) is 0.54 or 0.75, respectively, showed a percent retention of high rate discharge capacity after 30 days of storage in discharged state as low as 72.7% and 73.3%, respectively.

On the other hand, it can be seen that the batteries U and W comprising the nickel positive electrode free of titanium compound (TiO₂) and the hydrogen-absorbing alloy negative electrode made of hydrogen-absorbing alloy represented by the chemical formula MmNiₐCo_{b}Mn_{c}M_{d} in which c/(c+d) is 0.54 or 0.75, respectively, showed a percent retention of high rate discharge capacity after 30 days of storage in discharged state as low as 71.2% and 70.7%, respectively. It can thus be said that when the hydrogen-absorbing alloy negative electrode made of a hydrogen-absorbing alloy represented by the chemical formula MmNiₐCo_{b}Mn_{c}M_{d} in which c/(c+d) is 0.54 or 0.75 is used, the desired effect of titanium compound (TiO₂) cannot be exerted. It can be further seen that the batteries S and X comprising the hydrogen-absorbing alloy negative electrode made of hydrogen-absorbing alloy represented by the chemical formula MmNiₐCo_{b}Mn_{c}M_{d} in which c/(c+d) is 0.58 or 0.67, respectively, showed a percent retention of high rate discharge capacity as low as 70.7% and 70.8%, respectively.

Thus, the combined use of a hydrogen-absorbing alloy negative electrode made of a hydrogen-absorbing alloy represented by the chemical formula MmNiₐCo_{b}Mn_{c}M_{d} in which c/(c+d) is from 0.58 to 0.67 and a nickel positive electrode having a titanium compound (TiO₂) incorporated therein in an amount of 0.5% by mass makes it possible to exert a remarkable effect of enhancing the percent retention of high rate discharge capacity after storage in discharged state. The amount of the titanium compound (TiO₂) to be incorporated is preferably from 0.2% to 1.0% by mass similarly to the case of the niobium compound (Nb₂O₅). In this case, as the titanium compound there is preferably used Ti₂O₃, TiO or the like.

(2) Magnesium Compound

A positive active material slurry having a magnesium compound (MgO) incorporated therein in an amount of 0.5% by mass based on the mass of the positive active material was used. An electrode substrate made of foamed nickel was then filled with the positive active material slurry in the same manner as mentioned above. The electrode substrate was dried, rolled, and then cut into a predetermined size in the same manner as mentioned above to prepare a non-sintered nickel positive electrode n. The non-sintered nickel positive electrode n and the hydrogen-absorbing alloy negative electrodes h, j, k and l prepared as mentioned above were then used to prepare respective AA size nickel-hydrogen storage batteries having a nominal capacity of 1,250 mAh. The nickel-hydrogen storage battery comprising the positive electrode n and the negative electrode k was referred to as “battery Z5”. The nickel-hydrogen storage battery comprising the positive electrode n and the negative electrode h was referred to as “battery Z6”. The nickel-hydrogen storage battery comprising the positive electrode n and the negative electrode j was referred to as “battery Z7”. The nickel-hydrogen storage battery comprising the positive electrode n and the negative electrode l was referred to as “Z8”.

Subsequently, the batteries Z5 to Z8 thus prepared were each charged with a charge current of 100 mA at a temperature of 25° C. for 16 hours, and then discharged with a discharge current of 1,000 mA to a battery voltage of 1.0 V. Thereafter, these batteries were each charged with a charge current of 100 mA for 16 hours, and then discharged with a discharge current of 4,000 mA to 0.5 V. From the discharge time was then determined the initial high rate discharge capacity (mAh) of the batteries Z5 to Z8.

Subsequently, the batteries Z5 to Z8 which had been discharged were each allowed to stand at a temperature of 25° C. for 30 days, charged with a charge current of 100 mA for 16 hours, and then discharged with a discharge current of 4,000 mA to a battery voltage of 0.5 V. From the discharge time was then determined the aged high rate discharge capacity (mAh) of the batteries Z5 to Z8. The ratio (%) of the aged high rate discharge capacity (mAh) to the initial high rate discharge capacity (mAh) was then calculated as percent retention of high rate discharge capacity after aging. The results are set forth in Table 3. Table 3 also contains the results of the batteries U, S, W and X for comparison.

TABLE 3

| | Nickel | | | | | | | |
|---|---|---|---|---|---|---|---|---|
| | positive | | | | | Initial | | Percent |
| Kind of | electrode | | Hydrogen-absorbing alloy negative electrode | | | discharge | Aged | retention of |
| battery | Kind | MgO | Kind | Chemical formula | c/(c + d) | capacity | capacity | capacity |
| Z5 | n | 0.5 | k | MₘNi_{3.61}Co_{0.80}Mn_{0.32}Al_{0.27} | 0.54 | 835 | 610 | 73.1 |
| Z6 | n | 0.5 | h | MₘNi_{3.48}Co_{0.80}Mn_{0.42}Al_{0.30} | 0.58 | 841 | 826 | 98.2 |
| Z7 | n | 0.5 | j | MₘNi_{3.60}Co_{0.80}Mn_{0.40}Al_{0.20} | 0.67 | 836 | 821 | 98.2 |
| Z8 | n | 0.5 | l | MₘNi_{3.40}Co_{0.80}Mn_{0.60}Al_{0.20} | 0.75 | 828 | 605 | 73.1 |
| U | g | 0 | k | MₘNi_{3.61}Co_{0.80}Mn_{0.32}Al | 0.54 | 841 | 599 | 71.2 |
| S | g | 0 | h | MₘNi_{3.48}Co_{0.80}Mn_{0.42}Al_{0.30} | 0.58 | 840 | 594 | 70.7 |
| W | g | 0 | l | MₘNi_{3.40}Co_{0.80}Mn_{0.60}Al_{0.20} | 0.75 | 843 | 596 | 70.7 |
| X | g | 0 | j | MₘNi_{3.60}Co_{0.80}Mn_{0.40}Al_{0.20} | 0.67 | 842 | 596 | 70.8 |

As can be seen in the results shown in Table 3 above, the batteries Z6 and Z7 comprising the nickel positive electrode having a magnesium compound (WO2) incorporated therein in an amount of 0.5% by mass and a hydrogen-absorbing alloy negative electrode made of hydrogen-absorbing alloy represented by the chemical formula MmNiₐCo_{b}Mn_{c}M_{d} in which c/(c+d) is from 0.58 to 0.67 showed a percent retention of high rate discharge capacity after 30 days of storage in discharged state as high as 98.2%. It can also be seen that the batteries Z5 and Z8 comprising the nickel positive electrode having a magnesium compound (MgO) incorporated therein in an amount of 0.5% by mass and a hydrogen-absorbing alloy negative electrode made of hydrogen-absorbing alloy represented by the chemical formula MmNiₐCo_{b}Mn_{c}M_{d} in which c/(c+d) is 0.54 or 0.75, respectively, showed a percent retention of high rate discharge capacity after 30 days of storage in discharged state as low as 73.1%.

On the other hand, it can be seen that the batteries U and W comprising the nickel positive electrode free of magnesium compound (MgO) and the hydrogen-absorbing alloy negative electrode made of hydrogen-absorbing alloy represented by the chemical formula MmNiₐCo_{b}Mn_{c}M_{d} in which c/(c+d) is 0.54 or 0.75, respectively, showed a percent retention of high rate discharge capacity after 30 days of storage in discharged state as low as 71.2% and 70.7%, respectively. It can thus be said that when the hydrogen-absorbing alloy negative electrode made of a hydrogen-absorbing alloy represented by the chemical formula MmNiₐCo_{b}Mn_{c}M_{d} in which c/(c+d) is 0.54 or 0.75 is used, the desired effect of magnesium compound (MgO) cannot be exerted. It can be further seen that the batteries S and X comprising the positive electrode free of magnesium compound (MgO) and the hydrogen-absorbing alloy negative electrode made of hydrogen-absorbing alloy represented by the chemical formula MmNiₐCo_{b}Mn_{c}M_{d} in which c/(c+d) is 0.58 or 0.67, respectively, showed a percent retention of high rate discharge capacity as low as 70.7% and 70.8%, respectively.

Thus, the combined use of a hydrogen-absorbing alloy negative electrode made of a hydrogen-absorbing alloy represented by the chemical formula MmNiₐCo_{b}Mn_{c}M_{d} in which c/(c+d) is from 0.58 to 0.67 and a nickel positive electrode having a magnesium compound (MgO) incorporated therein in an amount of 0.5% by mass makes it possible to exert a remarkable effect of enhancing the percent retention of high rate discharge capacity after storage in discharged state. The amount of the magnesium compound (MgO) to be incorporated is preferably from 0.2% to 1.0% by mass similarly to the case of the niobium compound (Nb₂O₅). In this case, as the magnesium compound there is preferably used Mg(OH)₂ or the like besides MgO.

(3) Tungsten Compound

A positive active material slurry having a tungsten compound (WO₂) incorporated therein in an amount of 0.5% by mass based on the mass of the positive active material was used. An electrode substrate made of foamed nickel was then filled with the positive active material slurry in the same manner as mentioned above. The electrode substrate was dried, rolled, and then cut into a predetermined size in the same manner as mentioned above to prepare a non-sintered nickel positive electrode o. The non-sintered nickel positive electrode o and the hydrogen-absorbing alloy negative electrodes h, j, k and l prepared as mentioned above were then used to prepare respective AA size nickel-hydrogen storage batteries having a nominal capacity of 1,250 mAh. The nickel-hydrogen storage battery comprising the positive electrode o and the negative electrode k was referred to as “battery Z9”. The nickel-hydrogen storage battery comprising the positive electrode o and the negative electrode h was referred to as “battery Z10”. The nickel-hydrogen storage battery comprising the positive electrode o and the negative electrode j was referred to as “battery Z11”. The nickel-hydrogen storage battery comprising the positive electrode o and the negative electrode l was referred to as “Z12”.

Subsequently, the batteries Z9 to Z12 thus prepared were each charged with a charge current of 100 mA at a temperature of 25° C. for 16 hours, and then discharged with a discharge current of 1,000 mA to a battery voltage of 1.0 V. Thereafter, these batteries were each charged with a charge current of 100 mA for 16 hours, and then discharged with a discharge current of 4,000 mA to 0.5 V. From the discharge time was then determined the initial high rate discharge capacity (mAh) of the batteries Z9 to Z12.

Subsequently, the batteries Z9 to Z12 which had been thus discharged were each allowed to stand at a temperature of 25° C. for 30 days, charged with a charge current of 100 mA for 16 hours, and then discharged with a discharge current of 4,000 mA to a battery voltage of 0.5 V. From the discharge time was then determined the aged high rate discharge capacity (mAh) of the batteries Z9 to Z12. The ratio (%) of the aged high rate discharge capacity (mAh) to the initial high rate discharge capacity (mAh) was then calculated as percent retention of high rate discharge capacity after aging. The results are set forth in Table 4. Table 4 also contains the results of the batteries U, S, W and X for comparison.

TABLE 4

| | Nickel | | | | | | | |
|---|---|---|---|---|---|---|---|---|
| | positive | | | | | Initial | | Percent |
| Kind of | electrode | | Hydrogen-absorbing alloy negative electrode | | | discharge | Aged | retention of |
| battery | Kind | WO₂ | Kind | Chemical formula | c/(c + d) | capacity | capacity | capacity |
| Z9 | o | 0.5 | k | MₘNi_{3.61}Co_{0.80}Mn_{0.32}Al_{0.27} | 0.54 | 841 | 608 | 72.3 |
| Z10 | o | 0.5 | h | MₘNi_{3.48}Co_{0.80}Mn_{0.42}Al_{0.30} | 0.58 | 844 | 829 | 98.2 |
| Z11 | o | 0.5 | j | MₘNi_{3.60}Co_{0.80}Mn_{0.40}Al_{0.20} | 0.67 | 842 | 831 | 98.7 |
| Z12 | o | 0.5 | l | MₘNi_{3.40}Co_{0.80}Mn_{0.60}Al_{0.20} | 0.75 | 838 | 609 | 72.7 |
| U | g | 0 | k | MₘNi_{3.61}Co_{0.80}Mn_{0.32}Al | 0.54 | 841 | 599 | 71.2 |
| S | g | 0 | h | MₘNi_{3.48}Co_{0.80}Mn_{0.42}Al_{0.30} | 0.58 | 840 | 594 | 70.7 |
| W | g | 0 | l | MₘNi_{3.40}Co_{0.80}Mn_{0.60}Al_{0.20} | 0.75 | 843 | 596 | 70.7 |
| X | g | 0 | j | MₘNi_{3.60}Co_{0.80}Mn_{0.40}Al_{0.20} | 0.67 | 842 | 596 | 70.8 |

As can be seen in the results shown in Table 4 above, the batteries Z10 and Z11 comprising the nickel positive electrode having a tungsten compound (WO₂) incorporated therein in an amount of 0.5% by mass and a hydrogen-absorbing alloy negative electrode made of hydrogen-absorbing alloy represented by the chemical formula MmNiₐCo_{b}Mn_{c}M_{d} in which c/(c+d) is from 0.58 to 0.67 showed a percent retention of high rate discharge capacity after 30 days of storage in discharged state as high as 98.2% and 98.7%, respectively. It can also be seen that the batteries Z9 and Z12 comprising the nickel positive electrode having a tungsten compound (WO₂) incorporated therein in an amount of 0.5% by mass and a hydrogen-absorbing alloy negative electrode made of hydrogen-absorbing alloy represented by the chemical formula MmNiₐCo_{b}Mn_{c}M_{d} in which c/(c+d) is 0.54 or 0.75, respectively, showed a percent retention of high rate discharge capacity after 30 days of storage in discharged state as low as 72.3% and 72.7%, respectively.

On the other hand, it can be seen that the batteries U and W comprising the nickel positive electrode free of tungsten compound (WO₂) and the hydrogen-absorbing alloy negative electrode made of hydrogen-absorbing alloy represented by the chemical formula MmNiₐCo_{b}Mn_{c}M_{d} in which c/(c+d) is 0.54 or 0.75, respectively, showed a percent retention of high rate discharge capacity after 30 days of storage in discharged state as low as 71.2% and 70.7%, respectively. It can thus be said that when the hydrogen-absorbing alloy negative electrode made of a hydrogen-absorbing alloy represented by the chemical formula MmNiₐCo_{b}Mn_{c}M_{d} in which c/(c+d) is 0.54 or 0.75 is used, the desired effect of tungsten compound (WO₂) cannot be exerted. It can be further seen that the batteries S and X comprising the positive electrode free of tungsten compound (WO₂) and the hydrogen-absorbing alloy negative electrode made of hydrogen-absorbing alloy represented by the chemical formula MmNiₐCo_{b}Mn_{c}M_{d} which c/(c+d) is 0.58 or 0.67, respectively, showed a percent retention of high rate discharge capacity as low as 70.7% and 70.8%, respectively.

Thus, the combined use of a hydrogen-absorbing alloy negative electrode made of a hydrogen-absorbing alloy represented by the chemical formula MmNiₐCo_{b}Mn_{c}M_{d} in which c/(c+d) is from 0.58 to 0.67 and a nickel positive electrode having a tungsten compound (WO₂) incorporated therein in an amount of 0.5% by mass makes it possible to exert a remarkable effect of enhancing the percent retention of high rate discharge capacity after storage in discharged state. The amount of the tungsten compound (WO₂) to be incorporated is preferably from 0.2% to 1.0% by mass similarly to the case of the niobium compound (Nb₂O₅). In this case, as the tungsten compound there is preferably used WO₃, Na₂WO₄ or the like besides WO₂.

As mentioned above, the positive electrode to be used in the invention comprises at least one compound selected from the group consisting of niobium compound, titanium compound, magnesium compound and tungsten compound incorporated therein. In this arrangement, the rate at which the cobalt compound covering the surface of nickel hydroxide is dissolved and precipitated in the electrolytic solution can be lowered. As a result, the structure of the cobalt compound layer can be rendered denser, making it possible to improve the conduction network. Further, the denser structure of the cobalt compound layer can prevent metals such as Mn, Al, Ca and Mg constituting the hydrogen-absorbing alloy which have been eluted with the electrolytic solution after prolonged storage from penetrating into the cobalt coat layer, making it possible to maintain a good conduction network.

A hydrogen-absorbing alloy represented by the chemical formula MmNiₐCo_{b}Mn_{c}M_{d} (in which M represents at least one element selected from the group consisting of Ca, Mg and Al) is used as a negative electrode. In this arrangement, metals such as Mn, Al, Ca and Mg in the hydrogen-absorbing alloy can be prevented from being eluted with the electrolytic solution and deposited again on the surface of the hydrogen-absorbing alloy. Further, the hydrogen-absorbing alloy satisfies the relationship between the composition ratio (c) of Mn and the composition ratio (d) of M (Ca, Mg, Al): 0.58≦c/(c+d)≦0.67, the effect of niobium, titanium, magnesium or tungsten compound incorporated in the positive electrode can be maximized.

The active material made of nickel hydroxide preferably comprises one element selected from the group consisting of zinc, cobalt, magnesium, aluminum, manganese, yttrium and ytterbium solid-dissolved therein in an amount of not greater than 10 atm-% based on the total amount of nickel hydroxide and the element. In this arrangement, the element thus solid-dissolved in nickel hydroxide acts to prevent potassium ions and other ions in the alkaline electrolytic solution from being intercalated into the crystalline nickel hydroxide, making it possible to inhibit the drop of discharge capacity due to the drying-out of the alkaline electrolytic solution.

Further, when the nickel positive electrode comprises one element selected from the group consisting of yttrium, ytterbium, erbium and zinc or a compound thereof incorporated therein in powder form besides the aforementioned niobium, titanium, magnesium and tungsten compounds, a better conduction network can be formed in the positive electrode to further enhance the percent utilization of active material, making it possible to obtain a high capacity storage battery. Further, since high order nickel hydroxide can be stored stably over an extended period of time, an effect can be exerted of further enhancing the percent retention of high rate discharge capacity after storage in discharged state. In this case, it is particularly preferred that Y₂O₃ be used as a yttrium compound.

While the invention has been described in detail and with reference to specific embodiments thereof, it will be apparent to one skilled in the art that various changes and modifications can be made therein without departing from the spirit and scope thereof.

What is claimed is:

1. A nickel-hydrogen storage battery comprising:
a positive electrode containing a positive active material mainly composed of nickel hydroxide coated with a cobalt compound, said positive active material being added at least one compound selected from the group consisting of niobium compound, titanium compound, magnesium compound and tungsten compound;
a negative electrode containing a negative active material mainly composed of a hydrogen-absorbing alloy; and
an alkaline electrolytic solution,
wherein said negative electrode comprises a CaCu₅ type hydrogen-absorbing alloy represented by the chemical formula MmNiₐCo_{b}Mn_{c}M_{d} (in which M represents at least one element selected from the group consisting of Ca, Mg and Al), with the proviso that the ratio (c/(c+d)) of the composition (c+d) of Mn and M to the composition (c) of Mn has the following relationship:
0.58≦c/(c+d)≦0.67.

2. The nickel-hydrogen storage battery according to claim 1, wherein the cobalt compound contains alkaline cations.

3. The nickel-hydrogen storage battery according to claim 1, wherein the content of the at least one compound selected from the group consisting of niobium compound, titanium compound, magnesium compound and tungsten compound is from not smaller than 0.2% by mass to not greater than 1.0% by mass based on the mass of the positive material mainly composed of nickel hydroxide coated with a cobalt compound.
